(19) United States
(12) Patent Application Publication
(10) Pub. No.: US 2020/0016586 A1
(43) Pub. Date: Jan. 16, 2020

(54) CATALYST-ADHERED BODY PRODUCTION METHOD AND CATALYST ADHESION DEVICE

(71) Applicants: WASEDA UNIVERSITY, Shinjuku-ku Tokyo (JP); ZEON CORPORATION, Chiyoda-ku, Tokyo (JP)

(72) Inventors: Suguru NODA, Shinjuku-ku, Tokyo (JP); Risa MAEDA, Shinjuku-ku, Tokyo (JP); Akiyoshi SHIBUYA, Chiyoda-ku, Tokyo (JP)

(73) Assignees: WASEDA UNIVERSITY, Shinjuku-ku Tokyo (JP); ZEON CORPORATION, Chiyoda-ku Tokyo (JP)

(21) Appl. No.: 16/484,579

(22) PCT Filed: Feb. 16, 2018
(86) PCT No.: PCT/JP2018/005582

§ 371 Date: Aug. 8, 2019

(30) Foreign Application Priority Data
Feb. 17, 2017 (JP) 2017-028203

(51) Int. Cl. B01J 37/02; B01J 23/745; B01J 23/75; B01J 23/755; B01J 35/10; B01J 37/04

(52) U.S. Cl. CPC B01J 37/0209; B01J 23/745; B01J 23/75; B01J 21/18; B01J 35/10; B01J 37/0236; B01J 37/04; B01J 23/755

(57) ABSTRACT

A catalyst-adhered body production method comprising an adhesion process for arranging a mixed liquid comprising a catalyst raw material and/or a catalyst carrier raw material and target particles in a container having a porous plate and adhering a catalyst and/or a catalyst carrier to the surface of target particles to obtain adherence-treated particles, an excess solution removal process for removing via the porous plate, at least a portion of excess solution comprising excess components which did not adhere to the adherence-treated particles from the container, to form a filled layer of the adherence-treated particles on the porous plate, and a drying process for drying the filled layer in the container.

### TECHNICAL FIELD

The present disclosure relates to a catalyst-adhered body production method and a catalyst adhesion device.

### BACKGROUND

In recent years, fibrous carbon materials, specifically, fibrous carbon nanostructures such as carbon nanotubes (hereinafter, referred to as “CNTs”) have been attracting attention as materials having excellent electrical conductivity, thermal conductivity, and mechanical characteristics. CNTs are formed by cylindrical graphene sheets constructed from carbon atoms, and their diameter is on the order of nanometers.

Fibrous carbon nanostructures such as CNTs are generally more expensive than other materials because of their high production cost. Accordingly, the uses of fibrous carbon nanostructures such as CNTs are limited, despite their excellent characteristics mentioned above. Furthermore, in recent years, a Chemical Vapor Deposition (CVD) method using a catalyst (hereinafter, referred to as “catalytic CVD method”) has been employed as a production method capable of producing CNTs and the like with relatively high efficiency. Even with the catalytic CVD method, however, the production cost could not be sufficiently reduced. Note that, the catalytic CVD method includes a method for using a supported catalyst obtained by supporting a catalyst on a support such as a substrate, and a method for using a catalyst without a support. When preparing the supported catalyst, first, the catalyst is adhered on a support to obtain a catalyst-adhered body, and the supported catalyst is produced by firing and reducing the catalyst-adhered body.

A production method and a production device which uses porous particles, ceramic beads, and the like as a support in place of the substrate has been considered for the purpose of increasing the production efficiency of fibrous carbon nanostructures such as CNTs (refer to, for example PTL1 and NPL1). In PTL1, the catalyst is supported on a particulate support to obtain the supported catalyst by a so-called “dry” production method in which the catalyst raw material and the like are supplied together with a carrier gas. More specifically, PTL1 discloses a production method for synthesizing CNTs by forming a catalyst carrier layer comprising Al₂O₃ on alumina beads as a support by sputtering, and furthermore, forming a fluidized bed with the supported catalyst formed by supporting an Fe catalyst on the catalyst carrier layer by the catalyst raw material vapor. Note that, the method described in PTL1 simultaneously and progressively performs the adherence, firing, and reduction of the catalyst to obtain the supported catalyst. Further, NPL1 discloses a so-called “wet” production method of a catalyst-adhered body comprising impregnating and stirring a support in a solution containing the catalyst raw material and the like to perform a catalyst adhesion process for adhering the catalyst to the support.

### CITATION LIST

### Patent Literature

PTL 1: WO 2009/110591

### Non-Patent Literature

NPL 1: F. Wei, and four others, “Mass Production of aligned carbon nanotube arrays by fluidized bed catalytic chemical vapor deposition”, Carbon, Elsevior, April 2010, Vol. 48, No. 4, p. 1196-1209

### SUMMARY

### Technical Problem

Here, the dry production method described in PTL1 is disadvantageous in that a large amount of carrier gas is required and in that it is necessary to highly control the carrier atmosphere. Namely, the dry production method described in PTL1 has room for improvement in terms of the production efficiency. On the other hand, a wet production method such as that described in NPL1 is advantageous compared to the dry production method in that a carrier gas is not required, and in that high degree of control of the carrier atmosphere is not required. However, as described in NPL1, in the wet production method, it takes 5 hours to make a catalyst raw material solution mixed with and impregnated into a vermiculite powder which is a clay mineral at 80° C., 11 hours to dry the filtrated cake at 110° C., and furthermore, one hour to fire the resultant at 400° C., therefore as long as 17 hours was required. The synthesis by the CVD method of fibrous carbon nanostructures such as CNTs from such a produced supported catalyst normally takes from ten minutes to one hour, and requires a large volume catalyst production device several tens of time larger than the CVD synthesis device, and this was a large factor in the high cost. In addition, it is necessary to dry the support which is in a wet state immediately after the catalyst adhesion process, but a wet support is difficult to handle, and the mode of handling can become a factor which decreases the catalyst adherence efficiency. However, in NPL1, the details of handling a wet support are unknown.

An object of the present disclosure is to provide a catalyst-adhered body production method and a catalyst adhesion device, which achieve a good production efficiency.

### Solution to Problem

The inventors made extensive studies to solve the aforementioned problems. The inventors newly discovered that the catalyst adherence efficiency is significantly improved by arranging in a container having a porous plate a target particle which is the target to be supported with the catalyst raw material and the catalyst, and carrying out a series of processes from a wet adhesion process to a drying process in the same container, and completed the present disclosure.

Namely, it is an object of the present disclosure to advantageously solve the aforementioned problems, and the catalyst-adhered body production method of the present disclosure comprises an adhesion process for arranging a mixed liquid containing a catalyst raw material and/or a catalyst carrier raw material and target particles in a container having a porous plate, and adhering a catalyst and/or a catalyst carrier to the surface of the target particles to obtain adherence-treated particles, an excess solution removal process for removing via the porous plate, at least a portion of an excess solution containing excess components which did not adhere to the adherence-treated particles from the container to form a filled layer of the adherence-treated particles on the porous plate, and the drying process for drying the filled layer in the container. The catalyst-adhered body production method of the present disclosure carries out a series of processes from the adhesion process to the drying process in the same container, and thus, has an excellent production efficiency.

Note that, in the present disclosure, the phrase “target particles” refers to the target particle to be carried with the catalyst, and is a particle containing a support for supporting the catalyst.

Further, in the catalyst-adhered body production method of the present disclosure, the adhesion process preferably comprises a solution supply step for supplying a solution containing the catalyst raw material and/or the catalyst carrier raw material to the target particles filled in the container to obtain the mixed liquid. The operation for filling the target particles in the container, and then supplying the solution containing the catalyst raw material and/or the catalyst carrier raw material to make a mixed liquid can simplify the operation in the adhesion process and can further improve the adherence efficiency.

Further, the catalyst-adhered body production method of the present disclosure preferably comprises supplying a mixed solution containing the catalyst raw material and the catalyst carrier raw material in the solution supply step. By supplying the mixed solution containing the catalyst raw material and the catalyst carrier raw material to the target particle which was initially filled in the container, it is possible to further improve the adherence efficiency and to improve the quality of the obtained catalyst-adhered body.

Further, in the adhesion process of the catalyst-adhered body production method of the present disclosure, the adhesion process may contain a premixing step for premixing the solution containing the catalyst raw material and/or the catalyst carrier raw material with the target particles outside of the container to obtain the mixed liquid, and a mixed liquid injection step for injecting the mixed liquid obtained in the premixing step into the container. According to such an operation, the uniformity of the amount of adherence in the catalyst-adhered body surface can be further improved.

Further, the catalyst-adhered body production method of the present disclosure may include mixing the mixed solution containing the catalyst raw material and the catalyst carrier raw material with the target particles in the premixing step. By mixing the mixed solution containing the catalyst raw material and the catalyst carrier raw material with the target particles in the premixing step, the quality of the obtainable catalyst-adhered body can be improved.

Further, in the catalyst-adhered body production method of the present disclosure, the excess solution removal process preferably includes transporting the excess solution from a high pressure side space to a low pressure side space by creating a pressure difference between a space in contact with one side of the porous plate and a space in contact with the other side. According to such an operation, the catalyst adherence efficiency can be further improved by reducing the time required for the excess solution removal process.

Further, in the catalyst-adhered body production method of the present disclosure, the drying process preferably includes flowing a gas through the filled layer of the adherence-treated particles and/or in the container. If the adherence-treated particles are dried by a flow of gas in the drying process, the catalyst adherence treatment efficiency can be further improved, and the adherence density on the particle surface can be made uniform.

Further, in the catalyst-adhered body production method of the present disclosure, a volume-average particle diameter of the target particles is preferably from 0.1 mm to 2.0 mm. If the volume-average particle diameter of the target particles is within the aforementioned range, the catalyst adherence efficiency can be further improved.

Note that, in the present disclosure, the “volume-average particle diameter of the target particles” can be measured as prescribed in, for example, JIS Z8825, and represents the particle diameter (D50) at which, in a particle size distribution (volume basis) measured by laser diffraction, the cumulative volume calculated from the small diameter end of the distribution reaches 50%.

Further, in the catalyst-adhered body production method of the present disclosure, the catalyst carrier raw material preferably contains one or more elements among Al, Si, Mg, Fe, Co, Ni, O, N, and C. If the catalyst carrier raw material contains one or more of these specific elements, the catalytic activity of the supported catalyst prepared through the obtainable catalyst-adhered body can be improved.

Further, in the catalyst-adhered body production method of the present disclosure, the target particle preferably contains one or more elements among Al, Si, Zr, O, N, and C, and the catalyst raw material preferably contains one or more elements among Fe, Co, and Ni. If the target particles contain one or more of these specific elements, the catalytic activity of the supported catalyst prepared through the obtainable catalyst-adhered body can be improved.

Further, in the catalyst-adhered body production method of the present disclosure, the catalyst raw material in the excess solution removed from the container in the excess solution removal process is preferably used as at least one part of the catalyst raw material. The catalyst adherence efficiency can be further improved in terms of the efficiency of utilization of the raw materials.

Furthermore, it is an object of the present disclosure to advantageously solve the aforementioned problems, and the catalyst-adhered body production device of the present disclosure comprises, a container containing an internal space in which at least one part of a bottom surface is defined by a porous plate, a liquid removal mechanism for removing liquid from the internal space through the porous plate, and a drying mechanism for drying a granular material arranged in the internal space. The catalyst-adhered body production device of the present disclosure enables to carry out a series of processes from the adhesion process to the drying process in the same container, and thus, has an excellent catalyst adherence efficiency.

Further, the catalyst-adhered body production device of the present disclosure is preferably further containing a stirring mechanism for stirring the granular material arranged in the internal space. If the catalyst-adhered body production device is equipped with a stirring mechanism, the uniformity of the catalyst adherence of the obtainable catalyst-adhered body can be further improved.

Further, the catalyst-adhered body production device of the present disclosure is preferably further equipped with a circulation line for making the liquid removed from the internal space via the porous plate again flow into the internal space. If the catalyst-adhered body production device is equipped with the circulation line, the production efficiency can be further improved in terms of the efficiency of utilization of the raw material.

### Advantageous Effect

According to the present disclosure, a catalyst-adhered body production method and a catalyst adhesion device, which achieve a good production efficiency, can be provided.

### BRIEF DESCRIPTION OF THE DRAWINGS

In the accompanying drawings:

FIG. 1 is a schematic diagram illustrating an example of the configuration of a catalyst adhesion device of the present disclosure;

FIG. 2 is an SEM image illustrating the results of the CNTs synthesized using the catalyst-adhered body obtained by the example of the catalyst-adhered body production method of the present disclosure;

FIG. 3 is an SEM image illustrating the results of the CNTs synthesized using the catalyst-adhered body obtained by another example of the catalyst-adhered body production method of the present disclosure; and

FIG. 4 is an SEM image illustrating the results of the CNTs synthesized using the catalyst-adhered body obtained by another example of the catalyst-adhered body production method of the present disclosure.

### DETAILED DESCRIPTION

Embodiments of the present disclosure will be described in detail below.

The catalyst-adhered body production method of the present disclosure can produce the catalyst-adhered body which can be suitably used in the production of the fibrous carbon nanostructures and the fibrous carbon materials. Examples of the fibrous carbon nanostructures include carbon nanotubes, carbon nanofibers and the like. Further, the catalyst-adhered body production method of the present disclosure may be carried out by any device without any limitation as long as the various processes specified below can be carried out, but can be suitably carried out, for example, by the catalyst adhesion device of the present disclosure.

(Catalyst-Adhered Body Production Method)

The catalyst-adhered body production method of the present disclosure includes an adhesion process for arranging the mixed liquid comprising the catalyst raw material and/or the catalyst carrier raw material and the target particles in the container having the porous plate, and adhering the catalyst and/or the catalyst carrier to the surface of the target particles to obtain the adherence-treated particles, an excess solution removal process for removing via the porous plate, at least a portion of an excess solution comprising excess components which did not adhere to the adherence-treated particles to form a filled layer of the adherence-treated particles on the porous plate, and a drying process for drying the filled layer in the container. The catalyst-adhered body production method of the present disclosure can significantly improve the production efficiency by carrying out a series of processes from the adhesion process to the drying process in the same container in this way.

Furthermore, the adhesion process, the excess solution removal process, and the drying process define one set of these processes in this order, and multiple sets can be carried out. When carrying out multiple sets, only the catalyst carrier adheres to the target particles in the adhesion process of the first set, in the second and subsequent adhesion processes, at least the catalyst raw material is contained in the mixed liquid, and the catalyst carrier raw material may be optionally contained therein. On the other hand, when carrying out multiple sets, both of the catalyst carrier and the catalyst may adhere to the target particles in the adhesion process of each set.

By repeating these processes in multiple sets, not only does the amount of the catalyst and/or the catalyst carrier adhered in the obtainable catalyst-adhered body increase, but there are cases in which the catalyst and/or the catalyst carrier can be uniformly adhered on the catalyst-adhered body. The reasons therefor are unclear, but it is considered that this alleviates the influence of bias of the amount of adherence caused by a phenomenon referred to as liquid bridging which can occur when the filled layer comprised of the granular material is brought into contact with the liquid. First, in the filled layer of the adherence-treated particles in a wet state formed in the excess solution removal process, liquid remains between particles, and a state in which adjacent particles are crosslinked by the liquid may be formed. The “bridging” by the liquid contains solutes for the catalyst raw material and/or the catalyst carrier raw material and the like, thus, more of the catalyst and/or the catalyst carrier adheres to the portion of the target particle surface in contact with the bridging portion than the portion which is not in contact with the bridging. Therefore, in the adherence-treated particles obtained via one set of the aforementioned processes, there are mixed the portion to which many of the catalysts and/or the catalyst carriers adhered due to the liquid bridging and the portions to which catalysts and/or the catalyst carriers do not adhere like the above. Therefore, by carrying out multiple sets, it is considered that the target particles and the solution interact in the mixed liquid arranged in the container in the adhesion process, the arrangement in the filled layer formed in the subsequent excess solution removal process is changed and another portion of the target particle surface contacts the bridging portion due to the liquid bridging, and thus, the influence of bias of the amount of adherence due to the liquid bridging can be alleviated.

Further, it is considered that carrying out the aforementioned three processes as one set, i.e., carrying out the drying process after the adhesion process and prior to carrying out the next adhesion process contributes to the uniformity of the catalyst adherence on the adherence treated particle surface. The reasons therefor are unclear, but it is presumed to be due to the following. First, when the adhesion process and the excess solution removal process were carried out multiple times without performing the intervening drying process, additional solution will be added to the filled layer of the adherence-treated particles in a wet state. In this case, it is presumed that the catalyst and/or the catalyst carrier which was adhered to the target particles at the initial adhesion process is washed away due to the additional solution added at the second adhesion process. Alternatively, it is presumed that the solution remaining between the particles in the filled layer of the adherence-treated particles in a wet state and the solution remaining between the particles in the second adhesion process interact with each other so that the amount of adherence becomes greater at the interface of both solutions than at other portions of the target particle surface. Therefore, when carrying out the adhesion process and the excess solution removal process multiple times, it is possible to adequately prevent the catalyst and/or the catalyst carrier which were already adhered to the target particles from falling off the target particle surface and the occurrence of bias in the amount of adherence at the target particle surface by intervening the drying process between the excess solution removal process and the next adhesion process. Accordingly, when the adhesion process is performed multiple times, it is presumed that the amount of adherence of the catalyst and/or the catalyst carrier in the target particle surface can be made uniform by carrying out the drying process after the adhesion process and prior to carrying out the next adhesion process. Furthermore, the amount of adherence of the catalyst and/or the catalyst carrier on the target particle surface can be made uniform even by a raw material decomposition process and a stirring process described in detail later.

Furthermore, as described above, the catalyst-adhered body production method of the present disclosure may include one set of the aforementioned processes, or the aforementioned processes may be repeated. Here, when only one set of the processes is included, it is preferable that a recovery process for recovering the adherence-treated particles from the inside of the container is carried out following the drying process of the set. Further, when including a repeat of the processes, it is preferable that the recovery process for recovering the adherence-treated particles from the inside of the container is carried following the drying process of the final set. Namely, by carrying out the recovery process following the drying process performed as the final process in the container, the adherence-treated particles are taken out from the container in a dry state, thus, the handling of the adherence-treated particles in the catalyst adherence process significantly improves.

<Adhesion Process>

In the adhesion process, the mixed liquid comprising the catalyst raw material and/or the catalyst carrier raw material and the target particles is arranged in the container having the porous plate, and the catalyst and/or the catalyst carrier is adhered to the surface of the target particles to obtain the adherence-treated particles. Furthermore, by optionally stirring the mixed liquid arranged in the container by a stirring method such as a shaker, a stirrer, an agitator, a liquid flow, and air bubble blowing, the catalyst and/or the catalyst carrier adheres more uniformly to the surface of the target particles.

Furthermore, the adhesion process preferably includes a solution supply step for supplying the solution comprising the catalyst raw material and/or the catalyst carrier raw material to the target particles filled in the container to obtain the mixed liquid. Initially, by filling the target particles in the container, and then supplying the solution, it is possible to simplify the manpower required in the adhesion process and adhere the catalyst and/or the catalyst carrier more efficiently. Furthermore, a catalyst raw material solution supply step preferably includes immersing the entire amount of the target particles filled in the container in the catalyst raw material solution. If the entire amount of the target particles is immersed in the catalyst raw material solution, the catalyst and/or the catalyst carrier can be adhered to the target particle surface without any unevenness.

Here, the following three types of solution may be used as the solution for supplying to the target particles in the adhesion process. These three solutions are 1) a catalyst raw material solution containing the catalyst raw material, and free of the catalyst carrier raw material; 2) a catalyst carrier raw material solution containing the catalyst carrier raw material, and free of the catalyst raw material; and 3) a mixed solution containing the catalyst raw material and the catalyst carrier raw material. Below, the aforementioned 1) or 2) solutions may be referred to as “single solution”. By using 3) the mixed solution in the adhesion process, the adherence efficiency further increases, and the quality of the obtainable catalyst-adhered body can be improved. Further, the adhesion process may include a step for sequentially adding any of the aforementioned single solutions to the target particles. In this case, 1) the catalyst raw material solution, and 2) the catalyst carrier raw material solution can be added to the target particles simultaneously or sequentially. Preferably, 2) the catalyst carrier raw material solution supply step for supplying the catalyst carrier raw material solution can be carried out at the same time as 1) the catalyst raw material solution supply step for supplying the catalyst raw material solution to the target particles, or prior to the catalyst raw material solution supply step. Note that, when the catalyst carrier raw material supply step is carried out prior to the catalyst raw material solution supply step, an excess catalyst carrier raw material solution discharge process for discharging the excess catalyst carrier raw material solution containing the excess catalyst carrier raw material which does not remain on the support to the outside of the container via the porous plate may be included after the catalyst carrier raw material solution supply step and after a predetermined reaction time has elapsed.

On the one hand, the adhesion process may include a premixing step for premixing the solution containing the catalyst raw material and/or the catalyst carrier raw material with the target particles outside of the container to obtain the mixed liquid, and a mixed liquid injection step for injecting the mixed liquid obtained in the premixing step in the container. According to such an operation, the uniformity of the amount of adherence in the catalyst-adhered body can be further improved. Moreover, three kinds of solutions the same as the aforementioned method in which the target particles are pre-filled in a container and then various solutions are added may be appropriately used as the solution which is mixed with the target particles at the premixing step.

[Target Particles]

The target particles are not specifically limited, and any known particles capable of carrying the catalyst can be used. Examples of such particles include particles containing a support including one or more elements among Al, Si, Zr, O, N, and C, and preferably, ceramic particles containing one or more of these elements. If the target particles contain one or more of any of these specific elements, the catalytic activity of the supported catalyst which can be prepared via the obtainable catalyst-adhered body can be improved. Specifically, alumina beads which are particulate alumina, silica beads which are particulate silica, zirconia beads which are particulate zirconia, and beads of various composite oxides may be used. Moreover, the volume-average particle diameter of the target particles is preferably 0.1 mm or more, more preferably 0.15 mm or more, and more preferably 2.0 mm or less. If the volume-average particle diameter of the target particles is within the aforementioned range, the adherence efficiency can be further improved.

Examples of the target particles include support particles on which no catalyst raw material adheres, so-called pure support particles, support particles on which the catalyst raw material and/or the catalyst carrier raw material is adhered, or, carrier particles with a used catalyst material.

Further, in the present disclosure, the “particle” may be, for example, a particle having an aspect ratio of less than 5. The aspect ratio of the target particle and the catalyst-adhered body can be confirmed, for example, by calculating the value (major axis/width orthogonal to the major axis) for any 100 target particles/catalyst-adhered bodies selected on the microscope image, and calculating the average value.

[Catalyst Raw Material]

A raw material containing at least one element from among Fe, Co, and Ni can be suitably used as the catalyst raw material. This is because the catalytic activity of the obtainable supported catalyst can be further increased. More specifically, examples of the catalyst raw material include organic metal salts such as acetate, citrate, or oxalate; inorganic metal salts such as nitrate or oxo acid salt; or an organometallic complex such as metallocene, of Fe, Co, or Ni. Thereamong, the catalyst raw material preferably includes Fe, is more preferably iron acetate or iron nitrate or ferrocene, and is most preferably iron acetate or iron nitrate. If the catalyst raw material contains Fe, the catalytic activity of the supported catalyst prepared via the obtainable catalyst-adhered body can be increased.

[Catalyst Carrier Raw Material]

The catalyst carrier raw material preferably contains one or more elements among Al, Si, Mg, Fe, Co, Ni, O, N, and C. Furthermore, the catalyst carrier raw material is preferably an oxide of any one or more of these elements. Thereamong, the catalyst carrier raw material preferably contains any of Al, Si, or Mg, and is preferably a metal oxide containing any among Al, Si, and Mg. Examples of a suitable catalyst carrier raw material include aluminum alkoxide which is an organometallic complex containing Al, aluminum nitrate which is an inorganic metal salt and the like, and thereamong, aluminum isopropoxide is preferable.

[Medium]

The medium constituting the mixed liquid comprising the catalyst raw material and/or the catalyst carrier and the target particles described above is not specifically limited, and various organic solvents such as water, alcohol solvents, ethers, acetone and toluene, and their mixed solvents can be used. Thereamong, alcohol solvents such as methanol, ethanol, and 2-propanol are preferable, and ethanol is more preferable from the viewpoint of suppressing the viscosity and surface tension of the mixed liquid from becoming excessively high so as to increase the ease of filtration through the porous plate. Furthermore, ethanol has a higher drying efficiency by aeration than water because the vapor pressure of ethanol is higher and the heat of vaporization is smaller than water.

[Mixed Liquid]

The mixed liquid comprising the catalyst raw material and/or the catalyst carrier raw material and the target particles, which are arranged in the container, can be prepared using the solution obtained by dissolving the catalyst raw material and/or the catalyst carrier raw material and the target particles with the various media listed above without any limitation. Note that, a reducing agent such as citric acid and ascorbic acid may be optionally contained in the mixed liquid. By blending a reducing agent in the mixed liquid, the stability of the catalyst raw material in the mixed liquid can be improved.

[Catalyst Raw Material Solution]

Examples of the catalyst raw material solution obtained by dissolving the catalyst raw material in a solvent include various solutions which can be obtained by combining the various catalyst raw material and various solvents listed above. Thereamong, iron nitrate-ethanol solution and iron acetate-ethanol solution are preferable. The ethanol solution has a low surface tension, has a good wettability to the target particles, and can make iron nitrate and iron acetate adhere uniformly.

[Catalyst Carrier Raw Material Solution]

Examples of the catalyst carrier raw material solution obtained by dissolving the catalyst carrier raw material in a solvent include various solutions which can be obtained by combining the various catalyst carrier raw material and various solvents listed above. Thereamong, an aluminum isopropoxide as the catalyst carrier raw material is preferably dissolved in an alcohol solvent, preferably ethanol to obtain an aluminum isopropoxide-ethanol solution.

[Catalyst-Catalyst Carrier Raw Material Mixed Solution]

Examples of the catalyst-catalyst carrier raw material mixed solution obtained by dissolving the catalyst raw material and the catalyst carrier raw material in a solvent include various solutions which can be obtained by combining the various catalyst raw materials, the various catalyst carrier raw materials, and the various solvents listed above. Thereamong, an iron nitrate-aluminum isopropoxide-ethanol solution or an iron acetate-aluminum isopropoxide-ethanol solution is preferable. Specifically, when the catalyst-catalyst carrier raw material mixed solution is the iron nitrate-aluminum isopropoxide-ethanol solution or the iron acetate-aluminum isopropoxide-ethanol solution, it is preferable that Fe is blended in the mixed solution at a ratio of 0.2 times to 5.0 times of Al based on the molar mass.

<Excess Solution Removal Process>

The excess solution removal process removes, via the porous plate, at least a portion of the excess solution comprising the excess components which did not adhere to the adherence-treated particles from the container to form the filled layer of the adherence-treated particles on the porous plate. Furthermore, the excess solution removal process preferably includes a step for transporting the excess solution from the high pressure side space to the low pressure side space by causing a pressure difference to occur between a space in contact with one side of the porous plate and a space in contact with the other side. According to such an operation, the catalyst adherence efficiency can be further improved by reducing the time required for the excess solution removal process. A gas can be supplied to the upper space of the porous plate to cause the pressure difference between the upper space and the lower space of the porous plate. In this way, the pressure in the upper space of the porous plate can be higher than the pressure in the lower space of the porous plate in order to “exclude” the excess solution from the upper space via the porous plate.

Note that, the “excess solution” removed from the container in this process, contains the excess components which did not adhere to the adherence-treated particles. Such “excess components” can be the catalyst raw material and/or the catalyst carrier raw material. The concentration of the components in the excess solution is almost the same as the concentration of each component in the catalyst raw material solution and the catalyst carrier raw material solution, and thus, the excess solution is efficient for reuse. Therefore, reusing the excess solution in the reuse process described later is advantageous in the point that the raw materials can be efficiently used.

<Drying Process>

The drying process dries the filled layer in the container. Carrying out the drying process in the same container as the container in which the aforementioned the adhesion process and the excess solution removal process were carried out can prevent the adherence-treated particles in a wet state from adhering to the inner wall and the like of the container which leads to loss, and the deterioration of the operating efficiency which may occur when removing the particles from the container in the wet state. Furthermore, the drying process preferably includes flowing a gas through the filled layer of the adherence-treated particles and/or in the container. If the adherence-treated particles are dried by the flow of the gas in the drying process, the catalyst adherence treatment efficiency can be further improved, and the adherence density on the particle surface can be made uniform.

The gas which can be used when carrying out the drying process by the flow of a gas is not specifically limited, and an inert gas such as nitrogen gas or argon gas can be used. Further, when water is used in the solvent of the mixed liquid, air can be used because there is no danger of an explosion. Furthermore, from the viewpoint of shortening the time required for the drying process to speed up the catalyst adherence, it is preferable to heat the gas to be flown in the drying process and/or the filled layer in the container. The heating temperature is not specifically limited, and can be made to, for example, 35° C. to 200° C.

<Stirring Process>

Note that, after the drying process, if the adhesion process is performed again, that is, as described above, when repeatedly carrying out one set of the processes consisting of the adhesion process, the excess solution removal process, and the drying process, the stirring process is preferably carried out after the drying process. Here, a stirring process means an operation to make the arrangement of the adherence-treated particles different from the state of the adhesion process. Since the mutual arrangement of the adherence-treated particles changes due to the stirring process and the position at which the liquid bridging is formed also changes, the amount of adherence of the catalyst and/or the catalyst carrier on the target particle surface can be made more uniform. The stirring process is not specifically limited, and can be carried out, for example, by vibrating the container by any means such as a mechanical mechanism, moving a stirring blade in the container, or flowing a gas.

<Raw Material Decomposition Process>

The catalyst-adhered body production method of the present disclosure preferably includes the raw material decomposition process after the aforementioned the excess solution removal process, or, after the aforementioned the drying process. If the raw material decomposition process for dissolving the catalyst raw material and/or the catalyst carrier raw material of the adherence treated particle surface is added, the amount of adherence of the catalyst and/or the catalyst carrier on the target particle surface can be made more uniform. By performing the raw material decomposition process to dissolve and immobilize the catalyst raw material and/or the catalyst carrier raw material on the adherence treated particle surface, it is possible to prevent the elution of the catalyst raw material and/or the catalyst carrier raw material in subsequent processes which can be performed by wet operations such as the adhesion process. Further, if the raw material decomposition process is carried out at any of these times to dissolve the catalyst raw material and/or the catalyst carrier raw material, the fixability of the catalyst and/or the catalyst carrier raw material to the target particle can be increased. Specifically, in the raw material decomposition process, a basic aqueous solution such as water, water vapor, and an aqueous ammonia solution, or an acidic aqueous solution such as an aqueous acetic acid solution is supplied to the filled layer of the adherence-treated particles as decomposition liquids. For example, when a metal alkoxide is adhered as the catalyst raw material and/or the catalyst carrier raw material, there are cases when it can be fixed as a metal hydroxide by hydrolysis. Further, when metal acetate was adhered as the catalyst raw material and/or the catalyst carrier raw material, there are cases when it can be fixed as the metal hydroxide if a basic aqueous solution such as an aqueous ammonia solution is supplied. The above-mentioned decomposition liquid which can be used in raw material decomposition is not specifically limited, may be supplied from above the filled layer, and may be supplied via the porous plate. Following the raw material decomposition process, a decomposition liquid removal process can be carried out for removing the liquid containing the decomposition liquid from the container through the porous plate.

Note that, when carrying out the raw material decomposition process after the drying process, a post-decomposition drying process is preferably carried out after the raw material decomposition process, prior to the start of the subsequent process. By carrying out the post-decomposition drying process, the adherence density of the catalyst and/or the catalyst carrier raw material on the particle surface can be made uniform, and furthermore, the reaction with the decomposition liquid of the catalyst raw material solution can be prevented in the subsequent process.

<Recovery Process>

After carrying out the adhesion process and the like a desired number of times, it is preferable to carry out a recovery process for recovering the adherence-treated particles which were dried from the container. The recovery process is not specifically limited, and can be carried out by transporting the adherence-treated particles from the container to a particle recovery container by gravity or an air flow.

<Annealing Process>

The adherence-treated particles (i.e., the catalyst-adhered body) recovered by the recovery process is not specifically limited, and can become a supported catalyst in which the catalyst adhered to a surface can exert a catalytic ability through an annealing process, a reduction process and the like according to a general method.

<Reuse Process>

It is preferable to use the catalyst raw material and/or the supported catalyst raw material in the excess solution removed from the container in the excess solution removal process as at least a part of the catalyst raw material and/or the supported catalyst raw material to be brought into contact with the target particles by the aforementioned adhesion process. In terms of the efficiency of utilization of the raw material, the catalyst adherence efficiency can be further improved. Specifically, in the reuse process, the excess solution as is, or, the excess solution to which the catalyst raw material and/or the supported catalyst raw material and/or solvent is added so that the concentration of the catalyst raw material and/or the supported catalyst raw material in the solution becomes the desired concentration, is used as various raw material solutions. When a solid content such as fragments of the target particle is contained in the excess solution, the solid content may normally be removed by filtration, precipitation and the like.

As stated above, the catalyst-adhered body obtained by the catalyst-adhered body production method according to the present disclosure is not specifically limited, and is made to be a supported catalyst via predetermined firing, reduction processes and the like, and then the supported catalyst can be suitably used in the synthesis such as of CNTs, carbon nanofibers, and fibrous carbon materials as a fixed bed catalyst in a synthesis method according to the Chemical Vapor Deposition (CVD) method, or, as a medium for forming a fluidized bed in a fluidized bed synthesis method.

(Catalyst Adhesion Device)

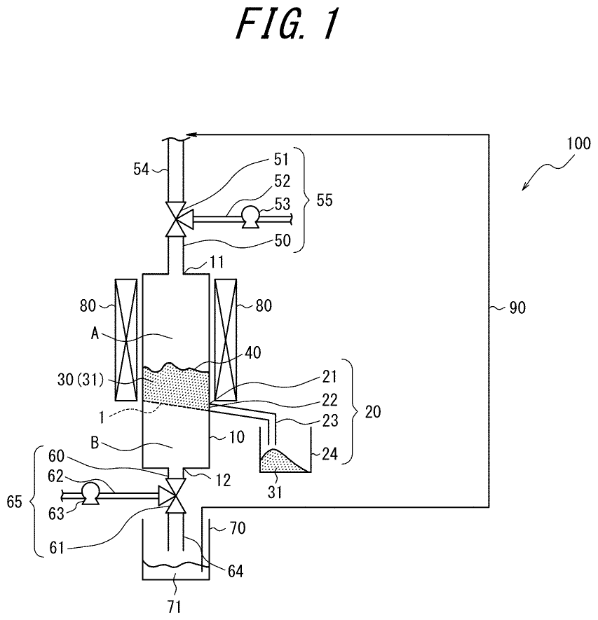

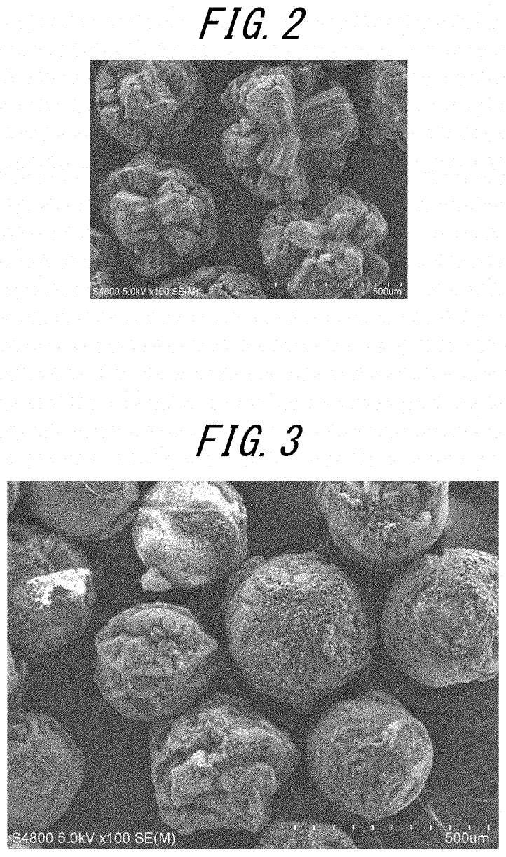

FIG. 1 is a schematic diagram illustrating an example of the configuration of a catalyst adhesion device of the present disclosure. A catalyst adhesion device 100 of the present disclosure comprises a porous plate 1 and a container 10. Furthermore, the catalyst adhesion device 100 may also comprise a particle recovery mechanism 20. The catalyst adhesion device 100, first, makes the catalyst and/or the catalyst carrier adhere to the surface of the target particle 30 in a mixed liquid 40 comprising the catalyst raw material and/or the catalyst carrier and the target particle 30 arranged in an internal space A in which at least one part of the bottom surface are defined by the porous plate 1 in the container 10 to obtain an adherence treated particle 31. Moreover, the catalyst adhesion device 100 removes, via the porous plate 1, at least a portion of the excess solution comprising the excess components which did not adhere to the adherence treated particle 31 from the internal space A to form the filled layer of the adherence-treated particles 31 on the porous plate 1. Furthermore, the catalyst adhesion device 100 dries the filled layer in the internal space A. Moreover, the dried adherence treated particle 31 can be recovered by a particle recovery mechanism 20, and can be processed in the following desired process such as annealing. Each component part will be described below.

<Porous Plate>

The porous plate 1 is not specifically limited as long as the target particles 30 can be maintained in the container 10, and may be configured by porous plate-like member. Apertures of the porous plate 1 may be equal to or less than the volume-average particle diameter of the target particles 30, and preferably are 200% or less of the volume-average particle diameter of the target particles. Even if the aperture is larger than the volume-average particle diameter of the target particles, specifically, when only the target particles are filled first, the target particles are maintained without being able to pass though the holes due to the friction between the target particles. More preferably, the aperture is 80% or less of the volume-average particle diameter of the target particles, and in this case, the target particles can be reliably maintained. Further, from the viewpoint of improving the liquid removal performance when removing the excess solution, the apertures are preferably 5% or more of the volume-average particle diameter of the target particles, and more preferably 30% or more.

<Container>

The container 10 comprises an upper opening 11 and a lower opening 12. The container 10 is not specifically limited, and may be configured by a quartz tube or a stainless steel tube. Further, in FIG. 1, the upper opening 11 and the lower opening 12 are depicted as having smaller opening areas than the cross-sectional area of the container 10 which is depicted as tubular member, but it is not limited to this kind of aspect, and the upper opening 11 and the lower opening 12 may have the same cross-sectional area as the cross-sectional area of the container 10. Namely, the container 10 may be configured by an open tube which is open at both ends. Further, FIG. 1 illustrates an aspect in which the upper opening 11 is provided on a longitudinal direction upper end surface of the container 10 and the lower opening 12 is provided on a longitudinal direction lower end surface the container 10, but the positions of the upper opening 11 and the lower opening 12 are not limited to this aspect. The upper opening 11 may be arranged at any position as long as it is on the upper side with respect to the porous plate 1, and in a position, which is the upper side relative to the water level that the mixed liquid 40 can take. The lower opening 12 may be arranged at any position as long as it is on the lower side relative to the porous plate 1.

Moreover, the container 10 contains the internal space A in which at least one part of the bottom surface is defined by the porous plate 1, and a lower internal space B in which at least one part of the upper surface is defined by the porous plate 1.

The catalyst adhesion device 100 can introduce, for example, the mixed liquid 40 comprising the catalyst raw material and the target particles 30 into the internal space A via the upper opening 11. Alternatively, the catalyst adhesion device 100, first, can introduce the target particles 30 in the internal space A via the upper opening 11, and then can introduce the solution containing the catalyst raw material and/or the catalyst carrier raw material. Note that, in the container 10, the catalyst and/or the catalyst carrier can be adhered to the target particles 30 in a state where the catalyst raw material and the like has not been adhered yet, and the catalyst and/or the catalyst carrier can be further adhered to the target particles 30 on which the catalyst raw material has already been adhered or supported such as the catalyst adherence treated particle which was subjected to the adhesion process at least one time and the supported catalyst which was used in the synthesis of CNTs and the like.

As shown in FIG. 1, an upper pipe 50 can be connected to the upper opening 11. Furthermore, the upper pipe 50 may have an upper three-way valve 51. This kind of upper three-way valve 51 can branch an upper air exhaust pipe 52 from the upper pipe 50. The upper air exhaust pipe 52, furthermore, has an upper blower 53. When the upper air exhaust pipe 52 is connected with the upper pipe 50 by the upper three-way valve 51, the pressure in the internal space A is set higher than the pressure in the lower internal space B by the upper blower 53 blowing the gas to the internal space A, so that the liquid component (i.e., the excess solution) in the mixed liquid can be transported into the lower internal space B, and the excess solution can be removed from inside the internal space A. On the one hand, when the upper pipe 50 is connected with an upper fluid conduit 54 by the upper three-way valve 51, the desired liquid can be transported into the internal space A. The upper pipe 50, the upper three-way valve 51, the upper air exhaust pipe 52, and the upper blower 53 configure an upper air exhaust device 55 which exhausts the gas to the internal space A without passing through the porous plate 1. Note that, the upper air exhaust device 55 is not limited to being configured by these specific components 50 to 53, and can be configured by any component parts as long as the gas can be exhausted to the internal space A without passing through the porous plate 1.

Further, as shown in FIG. 1, a lower pipe 60 can be connected to the lower opening 12. Furthermore, the lower pipe 60 may have a lower three-way valve 61. This kind of lower three-way valve 61 can branch a lower air exhaust pipe 62 from the lower pipe 60. The upper air exhaust pipe 62, furthermore, has an upper blower 63. When the lower air exhaust pipe 62 is connected with the lower pipe 60 by the lower three-way valve 61, the pressure in the lower internal space B is set lower than the pressure in the internal space A, by the lower blower 63 exhausting the gas from the lower internal space B, so that the liquid component (i.e., the excess solution) in the mixed liquid can be transported into the lower internal space B, and the excess solution can be removed from inside the internal space A. On the one hand, when the lower pipe 60 is connected with an lower fluid conduit 64 by the lower three-way valve 61, the excess solution transported into the lower internal space B can be discharged from the lower internal space B to be transported to the excess solution storage container 70 which can temporarily store the excess solution 71. The lower pipe 60, the lower three-way valve 61, the lower air exhaust pipe 62, and the lower blower 63 constitute the lower air exhaust device 65 which exhausts the gas to the internal space A via the porous plate 1. Note that, the lower air exhaust device 65 is not limited to be configured by these specific components 60 to 63, and can be configured by any component parts as long as the gas can be exhausted to the internal space A via the porous plate 1.

To remove the excess solution from internal space A, the upper three-way valve 51, the lower three-way valve 61, the upper blower 53, and the lower blower 63 can be driven in cooperation. In this case, the upper blower 53 and the lower blower 63 may be driven together, or, only one may be driven. In this case, the upper three-way valve 51 and the lower three-way valve 61 may be in either an open state in communication with any pipe, or, a closed state not in communication with any pipe, in order to create a pressure difference between the internal space A and the lower internal space B.

Therefore, as stated above, the upper air exhaust device 55 and the lower air exhaust device 65 can function as liquid removal mechanisms for removing the excess solution from the internal space A. Furthermore, the upper air exhaust device 55 and the lower air exhaust device 65 can also function as drying mechanisms for drying the granular material (i.e., the adherence-treated particles 31) in the internal space A. When the upper air exhaust device 55 and the lower air exhaust device 65 function as the drying mechanisms, the upper air exhaust device 55 and the lower air exhaust device 65 can be driven so as to create a pressure difference between the internal space A and the lower internal space B to make the gas flow from the upper direction to the lower direction, or in the opposite direction thereof in the same manner as when the upper air exhaust device 55 and the lower air exhaust device 65 function as the liquid removal mechanism described above. Note that, when the upper air exhaust device 55 and the lower air exhaust device 65 function as the drying mechanisms, the channeling of the adherence-treated particles 31 can be prevented and a uniform drying is possible, by the gas flowing from the upper direction to the lower direction. Further, by flowing the gas from the lower direction to the upper direction during drying, the adherence-treated particles 31 can be stirred and a uniform drying is possible.

Furthermore, the catalyst adhesion device 100 preferably comprises a heating device 80 for heating the internal space A of the container 10 or the gas to be flown into the container 10. By heating the internal space A or the gas to be flown into the container 10 with the heating device 80 while drying the adherence-treated particles 31, the time required for drying can be shortened, and the catalyst adherence efficiency can be further improved. The heating device 80 is not specifically limited, and for example, can be configured so as to internally or externally heat them by electric furnace or a steam pipe. Note that, FIG. 1 illustrates an aspect in which the container 10 comprises the heating device 80, but the catalyst adhesion device 100 may also have a heating device mounted on the upper pipe 50 and/or the upper air exhaust pipe 52, or, a heating device mounted on the lower pipe 60 and/or the lower air exhaust pipe 62 in place of the heating device provided in the periphery of the container 10, or in addition thereto.

Furthermore, as stated before, the upper air exhaust device 55 and the lower air exhaust device 65 are not only for the excess solution removal and the drying of the granular material, but also can function as a stirring mechanism for stirring the adherence-treated particles 31 arranged in the internal space A. Even in this case, driving the upper air exhaust device 55 and the lower air exhaust device 65 to create a pressure difference between the internal space A and the lower internal space B is common when functioning as a liquid removal mechanism, but the flow pattern of the gas can be adjusted to a sufficient flow rate to produce the stirring operation, and can be adjusted to make an intermittent flow in accordance with need. Note that, when the upper air exhaust device 55 and the lower air exhaust device 65 function as a stirring mechanism, the adherence-treated particles 31 can be stirred in the container 10 by flowing the gas in the container 10 at any flow rate and pattern after the adherence-treated particles 31 were dried in the container 10. Further, when the upper air exhaust device 55 and the lower air exhaust device 65 function as the stirring mechanism, the adherence-treated particles 31 can be uniformly stirred by flowing the gas from the bottom to the top.

The upper air exhaust device 55 and the lower air exhaust device 65 may be manually operated to realize the various functions as described above, or may be automatically driven by a control unit (not shown) to realize the same functions. In this case, the control unit may be a computer comprising a Central Processing Unit (CPU), a memory and the like, or may be a microcomputer.

Furthermore, the catalyst adhesion device 100 may also be comprised of a pressure regulator configured so as to monitor each pressure in the internal space A and the lower internal space B and adjust the differential pressure. Moreover, when the catalyst adhesion device 100 comprises the pressure regulator, this kind of pressure regulator can be controlled in conjunction with the upper air exhaust device 55 and the lower air exhaust device 65 so as to adjust the differential pressure.

<Particle Recovery Mechanism>

The particle recovery mechanism 20 has a particle recovery port 21 which is at a side surface lower part of the internal space A of the container 10, and is arranged so that the lower end corresponds with the upper surface of the porous plate 1. Furthermore, the particle recovery mechanism 20 has a shutter 22 configured so as to open and close the particle recovery port 21, a particle recovery pipe 23 connected to the particle recovery port 21, and a particle recovery container 24 for temporarily storing the adherence-treated particles 31 which are a granular material transported via the particle recovery pipe 23. Such a particle recovery mechanism 20 can effectively recover the adherence-treated particles 31 prepared in the container 10.

<Circulation Line>

Furthermore, the adhesion device 100 preferably further comprises a circulation line 90 for making the liquid removed from the internal space A via the porous plate 1 again flow into the internal space A. The circulation line 90 re-supplies the liquid removed from the internal space A, namely, the excess solution to the internal space A, thus, the excess solution can be reused. Moreover, while not shown, the circulation line 90 may also have a liquid feed pump, a filter for removing the solid content in the excess solution, a densitometer which can detect the solution concentration of the excess solution and the like.

Note that, the example shown in FIG. 1 describes that the liquid removal mechanism, the drying mechanism, and the stirring mechanism can all be embodied by the upper air exhaust device 55 and the lower air exhaust device 65. However, without being limited to this kind of embodiment, the liquid removal mechanism, the drying mechanism, and the stirring mechanism can also be respectively embodied by other means. For example, the liquid removal mechanism may be a centrifugal filtration mechanism which can produce a differential pressure in the spaces above and below the porous plate 1 by a centrifugal force. Further, the drying mechanism may also be embodied by the heating device 80 as described above regardless of the flow of the gas produced by driving the upper air exhaust device 55 and the lower air exhaust device 65 as described above. Furthermore, the stirring mechanism may be a mechanism such as internal stirring blades and a vibration mechanism of a device which can impart vibration to the granular material in the container 10.

Further, the example shown in FIG. 1 illustrates the particle recovery mechanism 20 as a discharge port provided on the side surface of the container 10, but the configuration of the particle recovery mechanism is not limited to this aspect, and may be any structure as long as the granular material prepared in the container 10 can be recovered. For example, the particle recovery mechanism may be a mechanism which conveys the granular material in the container 10 upward by blowing a strong air from the lower air exhaust device 65, and discharges the granular material from the upper opening 11 to the outside of the container 10. Alternatively, the particle recovery mechanism may be a mechanism configured as a rotation mechanism which rotates the container 10 by 90° or more, and discharges the granular material from the upper opening 11 to the outside of the container 10 by this kind of rotation.

### EXAMPLES

The present disclosure will be specifically described based on the examples below, but the present disclosure is not limited to these examples. In the examples and the comparative examples, the adherence efficiency and the catalytic activity were measured and evaluated as follows.

<Adherence Efficiency>

### [Handling]

In the production process of the catalyst-adhered body in the examples and the comparative example, the handling was evaluated by the following criteria form the viewpoint of the handling efficiency of the particles and the extent of particle loss during the production process.

A: The operability was very good with no aggregation between the particles when taken out from the container and the particles did not adhere to the container wall, and the particle loss was small.

B: While there was aggregation between the particles when taken out from the container, the operability was good with little adherence of the particles to the container wall, and the particle loss was small.

C: The operability was poor with aggregation between the particles when taken out from the container, and the particles adhered to the solution wall, and the particle loss was large.

### [High Speed Performance]

The time required in the production process of the catalyst-adhered body in the examples and the comparative example was measured and evaluated by the following criteria.

A: Less than 40 minutes

B: 40 minutes or more

<Catalytic Activity>

By using the catalyst-adhered bodies obtained in the examples and the comparative examples, CNTs were synthesized under the following conditions, and evaluated by the following criteria.

### [CNT Synthesis Conditions]

First, a quartz boat accommodating the catalyst-adhered bodies obtained in the examples and the comparative examples was arranged in a horizontal cylindrical CVD device, and a 475 sccm mixed gas comprised of 50 sccm of hydrogen, 5 sccm of carbon dioxide, and 420 sccm of argon was flown at a normal pressure, while raising the temperature to 800° C., and maintained for 5 minutes to reduce the catalyst-adhered body. Moreover, a 500 sccm mixed gas of 5 sccm of acetylene (C₂H₂) as the carbon raw material, 50 sccm of hydrogen, 5 sccm of carbon dioxide, and 440 sccm of argon was supplied into the CNT synthesis device at a normal pressure for 10 minutes to synthesize the CNTs.

### [Evaluation Criteria]

After the aforementioned CNT synthesis process, the supported catalyst was observed by a scanning electron microscope (SEM), and evaluated by the following criteria. Among the supported catalysts identified in the observation field of view, five randomly selected supported catalysts were evaluated from the viewpoint of the CNT coverage area and the CNT length according to the following criteria. The better the evaluation result means that the catalytic activity is higher.

### (1) Evaluation of CNT Coverage Area

A: 80% or more of the surface was covered by the CNTs.
B: 30% to less than 80% of the surface was covered by the CNTs.
C: 10% to less than 30% of the surface was covered by the CNTs.
D: Less than 10% of the surface was covered by the CNTs.

### (2) CNT Length

A: CNTs with a length of 100 μm or more were recognized.
B: CNTs with a length of 100 μm or more were not recognized.

### Example 1

### <Production of the Catalyst-Adhered Body>

A catalyst-adhered body production device comprising a container made of a quartz tube having an inner diameter of 2.2 cm having a porous plate (sintered body with 0.1 mm apertures) at the bottom was used.

30 g of alumina beads (volume-average particle diameter D50: 0.3 mm) which are the target particles were filled in the container. Furthermore, a 30 mM iron acetate (Fe(CH₃COO)₂)-36 mM aluminum isopropoxide (Al(OC₃H₇)₃)-ethanol solution which is a separately prepared catalyst-catalyst carrier raw material mixed solution was supplied into the container (first adhesion process). At this time, all of the alumina beads in the quartz tube were in a state immersed in the catalyst-catalyst carrier raw material mixed solution.

Moreover, nitrogen gas was flown from the upper pipe connected to the upper part of the quartz tube, the excess solution of the catalyst-catalyst carrier raw material mixed solution was removed from inside the quartz tube (first excess solution removal process), and the alumina beads which are the adherence-treated particles inside the quartz tube were dried (first drying process). The temperature of the upper pipe at this time was 18° C., and the temperature of the quartz tube was 23° C.

Moreover, the filled layer of dried adherence-treated particles was stirred by vibrating the quartz tube. 0.1 M aqueous ammonia solution was supplied to the filled layer (raw material decomposition process). Moreover, the heated nitrogen gas was flown from the upper pipe connected to the upper part of the quartz tube, the 0.1 M aqueous ammonia solution was removed from inside the quartz tube (decomposition liquid removal process), and the filled layer of the alumina beads which is the decomposition process particle inside the quartz tube was dried (post-decomposition drying process). The temperature of the upper pipe at this time was 150° C., and the temperature of the quartz tube was 100° C.

Moreover, the filled layer of dried decomposition process particle was stirred by vibrating the quartz tube. The catalyst-catalyst carrier raw material mixed solution having the same composition as the first adhesion process was supplied (second adhesion process). Moreover, the heated nitrogen gas was flown from the upper pipe connected to the upper part of the quartz tube, the excess solution was removed from the quartz tube (second excess solution removal process), and the alumina beads which are the twice treated adherence particles inside the quartz tube were dried (second drying process). The temperature of the upper pipe at the start of the second excess solution removal process was 90° C., and the temperature of the quartz tube was 40° C., the temperature of the upper pipe at the end of the second drying process was 70° C., and the temperature of the quartz tube was 20° C.

Moreover, the alumina beads which are the dried catalyst-adhered body after two sets of the adhesion process were recovered from inside the container (recovery process).

The alumina beads which are the recovered catalyst-adhered body were stored in the quartz boat, and the CNTs was synthesized by the aforementioned conditions. The results are shown in Table 1. Further, the SEM image of the supported catalyst after synthesis is shown in Table 2.

### Example 2

The production of the catalyst-adhered body and the synthesis of the CNTs were performed in the same manner as Example 1 with the exception that the catalyst-catalyst carrier raw material mixed solution used in the first adhesion process and the second adhesion process was changed to a 30 mM iron acetate (Fe(CH₃COO)₂)-24 mM aluminum isopropoxide (Al(OC₃H₇)₃)-ethanol solution. The results are shown in Table 1. Further, the image of the supported catalyst after synthesis is shown in FIG. 3.

### Example 3

The raw material decomposition process to the post-decomposition drying process were performed after the adhesion process to the drying process was performed using the catalyst carrier raw material solution, and one set of the adhesion process to the drying process using the catalyst-catalyst carrier raw material mixed solution was performed after three sets of this series of processes were repeated.

The operations were performed in the same manner as the first adhesion process to the first drying process of Example 1 with the exception that a 48 mM aluminum isopropoxide (Al(OC₃H₇)₃)-ethanol solution was used as the catalyst carrier raw material solution in place of the catalyst-catalyst carrier raw material mixed solution in the adhesion process to the drying process using the catalyst carrier raw material solution, and further, ion exchange water was used in the raw material decomposition process in place of the 0.1 M aqueous ammonia solution, and further, a heating device was not used in the drying process and the post-decomposition drying process.

In the raw material decomposition process, ion exchange water was supplied in an amount at which all of the adherence-treated particles in the quartz tube were immersed (raw material decomposition process). Moreover, room temperature nitrogen gas was flown from the upper pipe connected to the upper part of the quartz tube, ion exchange water was removed from inside of the quartz tube (decomposition liquid removal process), the filled layer of the alumina beads which are the decomposition process particles inside the quartz tube was dried (post-decomposition drying process).

The operations were performed in the same manner as the second adhesion process to second drying process of Example 1 with the exceptions that a 10 mM iron nitrate (Fe(NO₃)₂)-24 mM aluminum isopropoxide (Al(OC₃H₇)₃)-ethanol solution was used as the catalyst-catalyst carrier raw material mixed solution in the adhesion process to the drying process using the catalyst-catalyst carrier raw material mixed solution, and further, the ion exchange water was used in place of the 0.1 M aqueous ammonia solution in the raw material decomposition process, and further, a heating device was not used in the drying process and the post-decomposition drying process.

The obtained catalyst-adhered body was used to produce the supported catalyst and synthesize the CNTs in the same manner as Example 1. The results are shown in Table 1.

### Example 4

One set of the adhesion process to the drying process using the catalyst raw material solution was performed in place of the adhesion process to the drying process using the catalyst-catalyst carrier raw material mixed solution in Example 3. A 10 mM iron nitrate (Fe(NO₃)₂)-ethanol solution was used as the catalyst raw material solution. Each process was performed in the same manner as Example 3 with the exception of the aforementioned point. The obtained catalyst-adhered body was used to produce the supported catalyst and synthesize the CNTs in the same manner as Example 1. The results are shown in Table 1.

### Example 5

The catalyst-adhered body was obtained by performing one set of the same operations as the operations from the first adhesion process to the first drying process of Example 1 with the exception that a 20 mM iron acetate (Fe(CH₃COO)₂)-48 mM aluminum isopropoxide (Al(OC₃H₇)₃) ethanol solution was used. The obtained catalyst-adhered body was used to produce the supported catalyst and synthesize the CNT in the same manner as Example 1. The results are shown in Table 1.

### Example 6

The catalyst-adhered body was obtained by performing the same operation as in Example 5 with the exception that a 20 mM iron nitrate (Fe(NO₃)₂)-48 mM aluminum isopropoxide (Al(OC₃H₇)₃)-ethanol solution were used as the catalyst-catalyst carrier raw material mixed solution. The obtained catalyst-adhered body was used to produce the supported catalyst and synthesize the CNTs in the same manner as Example 1. The results are shown in Table 1.

### Example 7

The adhesion process to the post-decomposition drying process using the catalyst carrier raw material solution was performed twice by the same procedures as Example 3.

A 48 mM aluminum isopropoxide (Al(OC₃H₇)₃)-ethanol solution was used as the catalyst carrier raw material solution used in the first adhesion process and the second adhesion process.

A 10 mM iron nitrate (Fe(NO₃)₂) aqueous solution was supplied as the catalyst raw material solution to the filled layer of the obtained twice treated catalyst carrier adherence particles to perform the operations under the same conditions as the operation of the adhesion process to the drying process using the catalyst raw material solution of Example 4.

The obtained catalyst-adhered body was used to produce the supported catalyst and synthesize the CNTs in the same manner as Example 1. The results are shown in Table 1.

### Example 8

An aqueous 10 mM iron nitrate (Fe(NO₃)₂)-ethanol (Volume ratio 1:1 (mixed liquid) solution was supplied as the catalyst raw material solution to the filled layer of the twice treated catalyst carrier adherence particles obtained in the same manner as in Example 7 to perform the adhesion process to the drying process by the same conditions as in Example 7.

The obtained catalyst-adhered body was used to produce the supported catalyst and synthesize the CNTs in the same manner as Example 1. The results are shown in Table 1.

### Example 9

A 10 mM iron nitrate (Fe(NO₃)₂)-ethanol solution was supplied as the catalyst raw material solution to the filled layer of the twice treated catalyst carrier adherence particles obtained in the same manner as in Example 7 to perform the adhesion process to the drying process by the same conditions as in Example 7.

The obtained catalyst-adhered body was used to produce the supported catalyst and synthesize the CNTs in the same manner as Example 1. The results are shown in Table 1.

### Example 10

An ethanol solution containing 30 mM iron acetate (Fe(CH₃COO)₂), 24 mM aluminum isopropoxide (Al(OC₃H₇)₃), and 150 mM citric acid was used as the catalyst-catalyst carrier raw material mixed solution to perform the same operations as in the first adhesion process to the first drying process of Example 1. The obtained catalyst-adhered body was used to produce the supported catalyst and synthesize the CNTs in the same manner as Example 1. The results are shown in Table 1.

### Example 11

After performing the first adhesion process to the first drying process using the catalyst-catalyst carrier raw material mixed solution, the raw material decomposition process, the decomposition liquid removal process and the post-decomposition drying process were performed using ion exchange water and furthermore, the second adhesion process to the second drying process were performed using the catalyst-catalyst carrier raw material mixed solution.

A 30 mM iron acetate (Fe(CH₃COO)₂)-36 mM aluminum isopropoxide (Al(OC₃H₇)₃)-ethanol solution were prepared as the catalyst-catalyst carrier raw material mixed solution used in the first adhesion process and the second adhesion process. The specific operations in the first adhesion process to first drying process and the second adhesion process to second drying process are the same as the respective first adhesion process to first drying process and the second adhesion process to second drying process of Example 1.

The raw material decomposition process, the decomposition liquid removal process and the post-decomposition drying process were the same as those in Example 1 with the exception that ion exchange water was used in place of ammonia water. The catalyst-adhered body obtained in the aforementioned process was used to produce the supported catalyst and synthesize the CNTs in the same manner as Example 1. The results are shown in Table 1.

### Examples 12 to 15

The production of the catalyst-adhered body and the synthesis of the CNTs were performed in the same manner as Example 1 with the exception that alumina beads having the volume-average particle diameter as shown Table 1 were used as the target particles. The results are shown in Table 1.

### Examples 16 and 17

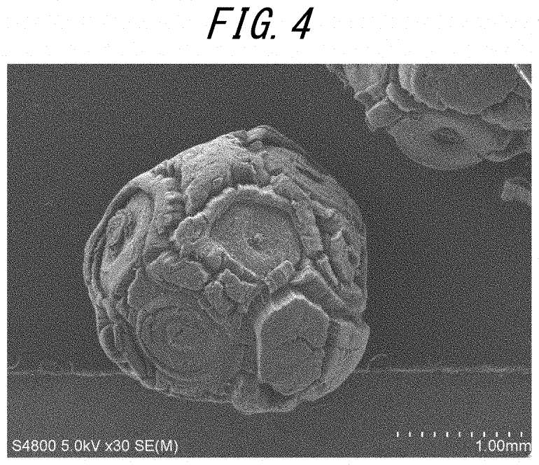

The production of the catalyst-adhered body and the synthesis of the CNTs were performed by the same process as the second adhesion process to second drying process of Example 1 with the exception that zirconia beads having the volume-average particle diameter as shown Table 1 were used as the target particles. The results are shown in Table 1. Further, the image of the supported catalyst after synthesis according to Example 17 is shown in FIG. 4.

### Comparative Example 1

A 10 mM iron acetate (Fe(CH₃COO)₂)-24 mM aluminum isopropoxide (Al(OC₃H₇)₃)-ethanol solution was used as the catalyst-catalyst carrier raw material mixed solution, and the catalyst-catalyst carrier raw material mixed solution was premixed in a beaker with 30 g of alumina beads (volume-average particle diameter D50: 0.3 mm) which are the target particles. The amount of the catalyst-catalyst carrier raw material mixed solution was the amount by which all of the alumina beads were immersed. The mixed liquid obtained by premixing was supplied into a suction filter (glass, Buchner type, filter surface diameter 6.5 cm) and subjected to suction filtration using a vacuum pump. A medicine spoon was used to move the catalyst adhere particles from the filled layer in a wet state to a quartz boat. The particles were sintered in an air atmosphere at 400° C. for 5 minutes, and the obtained catalyst-adhered body was used to synthesize the CNTs under the same conditions as in Example 1. The results are shown in Table 1.

In Table 1, “AliP” indicates aluminum isopropoxide (Al(OC₃H₇)₃), and “EtOH” indicates ethanol.

TABLE 1

| | | | Examples | | | | | | | | | |
|---|---|---|---|---|---|---|---|---|---|---|---|---|
| | | | 1 | 2 | 3 | 4 | 5 | 6 | 7 | 8 | 9 | 10 |
| Target | Type | | Al₂O₃ | Al₂O₃ | Al₂O₃ | Al₂O₃ | Al₂O₃ | Al₂O₃ | Al₂O₃ | Al₂O₃ | Al₂O₃ | Al₂O₃ |
| particle | D50[mm] | | 0.3 | 0.3 | 0.3 | 0.3 | 0.3 | 0.3 | 0.3 | 0.3 | 0.3 | 0.3 |
| Mixed | Catalyst | Type | Iron | Iron | Iron | — | Iron | Iron | — | — | — | Iron |
| solution | raw material | | acetate | acetate | nitrate | | acetate | nitrate | | | | acetate |
| treatment | | Concentration | 30 | 30 | 10 | — | 20 | 20 | — | — | — | 30 |
| | | [mM] | | | | | | | | | | |
| | Carrier | Type | AliP | AliP | AliP | — | AliP | AliP | — | — | — | AliP |
| | raw material | Concentration | 36 | 24 | 24 | — | 48 | 48 | — | — | — | 24 |
| | | [mM] | | | | | | | | | | |
| | Reducing agent | Type | — | — | — | — | — | — | — | — | — | Citric |
| | | | | | | | | | | | | acid |
| | | Concentration | — | — | — | — | — | — | — | — | — | 150 |
| | | [mM] | | | | | | | | | | |
| | Medium | Type | EtOH | EtOH | EtOH | — | EtOH | EtOH | — | — | — | EtOH |
| | Process Sets [No.] | | 2 | 2 | 1 | — | 1 | 1 | — | — | — | 1 |
| | Drying process | | Yes | Yes | Yes | — | Yes | Yes | — | — | — | Yes |
| Single | Catalyst | Type | — | — | — | Iron | — | — | Iron | Iron | Iron | — |
| solution | raw material | | | | | nitrate | | | nitrate | nitrate | nitrate | |
| treatment | | Concentration | — | — | — | 10 | — | — | 10 | 10 | 10 | — |
| | | [mM] | | | | | | | | | | |
| | Medium | Type | — | — | — | EtOH | — | — | H₂O | H₂O + | EtOH | — |
| | | | | | | | | | | EtOH | | |
| | Process Sets [No.] | | — | — | — | 1 | — | — | 1 | 1 | 1 | — |
| | Carrier | Type | — | — | AliP | AliP | — | — | AliP | AliP | AliP | — |
| | raw material | Concentration | — | — | 48 | 48 | — | — | 48 | 48 | 48 | — |
| | | [mM] | | | | | | | | | | |
| | Medium | | — | — | EtOH | EtOH | — | — | EtOH | EtOH | EtOH | — |
| | Process Sets [No.] | | — | — | 3 | 3 | — | — | 2 | 2 | 2 | — |
| Raw | Decomposition | Type | NH₃ | NH₃ | H₂O | H₂O | — | — | H₂O | H₂O | H₂O | — |
| material | liquid | | | | | | | | | | | |
| decomposition | Process Sets [No.] | | 1 | 1 | 3 | 3 | — | — | 1 | 1 | 1 | — |
| | Drying process | | Yes | Yes | Yes | Yes | — | — | No | No | No | — |
| Evaluation | Adherence | Handling | A | A | A | A | A | A | A | A | A | B |
| | efficiency | High speed | A | A | B | B | A | A | B | B | B | A |
| | | performance | | | | | | | | | | |
| | Activity | Coverage area | A | A | B | B | B | B | C | B | A | C |
| | | CNT length | A | B | A | A | B | B | B | B | B | B |

| | | | | | | | | | | Comparative |
|---|---|---|---|---|---|---|---|---|---|---|
| | | | Examples | | | | | | | Example |
| | | | 11 | 12 | 13 | 14 | 15 | 16 | 17 | 1 |
| Target | Type | | Al₂O₃ | Al₂O₃ | Al₂O₃ | Al₂O₃ | Al₂O₃ | ZrO₂ | ZrO₂ | Al₂O₃ |
| particle | D50[mm] | | 0.3 | 0.1 | 0.2 | 1.0 | 2.0 | 1.0 | 2.0 | 0.3 |
| Mixed | Catalyst | Type | Iron | Iron | Iron | Iron | Iron | Iron | Iron | Iron |
| solution | raw material | | acetate | acetate | acetate | acetate | acetate | acetate | acetate | acetate |
| treatment | | Concentration | 30 | 30 | 30 | 30 | 30 | 30 | 30 | 10 |
| | | [mM] | | | | | | | | |
| | Carrier | Type | AliP | AliP | AliP | AliP | AliP | AliP | AliP | AliP |
| | raw material | Concentration | 36 | 36 | 36 | 36 | 36 | 36 | 36 | 24 |
| | | [mM] | | | | | | | | |
| | Reducing agent | Type | — | — | — | — | — | — | — | — |
| | | Concentration | — | — | — | — | — | — | — | — |
| | | [mM] | | | | | | | | |
| | Medium | Type | EtOH | EtOH | EtOH | EtOH | EtOH | EtOH | EtOH | EtOH |
| | Process Sets [No.] | | 2 | 2 | 2 | 2 | 2 | 1 | 1 | 1 |
| | Drying process | | Yes | Yes | Yes | Yes | Yes | Yes | Yes | No |
| Single | Catalyst | Type | — | — | — | — | — | — | — | — |
| solution | raw material | Concentration | — | — | — | — | — | — | — | — |
| treatment | | [mM] | | | | | | | | |
| | Medium | Type | — | — | — | — | — | — | — | — |
| | Process Sets [No.] | | — | — | — | — | — | — | — | — |
| | Carrier | Type | — | — | — | — | — | — | — | — |
| | raw material | Concentration | — | — | — | — | — | — | — | — |
| | | [mM] | | | | | | | | |
| | Medium | | — | — | — | — | — | — | — | — |
| | Process Sets [No.] | | — | — | — | — | — | — | — | — |
| Raw | Decomposition | Type | H₂O | NH₃ | NH₃ | NH₃ | NH₃ | — | — | — |
| material | liquid | | | | | | | | | |
| decomposition | Process Sets [No.] | | 1 | 1 | 1 | 1 | 1 | — | — | — |
| | Drying process | | Yes | Yes | Yes | Yes | Yes | — | — | — |
| Evaluation | Adherence | Handling | B | A | A | A | A | A | A | C |
| | efficiency | High speed | A | A | A | A | A | A | A | A |
| | | performance | | | | | | | | |
| | Activity | Coverage area | A | B | A | A | A | A | A | D |
| | | CNT length | B | B | A | B | B | A | A | B |

It is understood from Table 1 that the handling of the particles was excellent in Examples 1 to 11 which include the process of drying, in the container, the adherence-treated particles subjected to the adhesion process and the like. Furthermore, it is understood that the supported catalyst prepared using the catalyst-adhered body obtained in Examples 1 to 11 had a high catalytic activity compared to the supported catalyst prepared using the catalyst-adhered body according to Comparative Example 1.

Specifically, by the comparison between Examples 1 and 2 and Examples 3 and 4, it is understood that by carrying out repeatedly the adhesion process and the like using the catalyst-catalyst carrier raw material mixed solution, and by interposing the raw material decomposition process using NH₃ between the multiple adhesion processes, the adherence efficiency and the catalytic activity can increase in a well balance manner. Further, it is understood that by using a heating device in the drying process after adhesion, the aqueous solvent can be dried rapidly, and the high speed performance is improved.

Further, it is understood from Examples 5 and 6 that it is possible to produce a catalyst-adhered body capable of preparing the supported catalyst capable of exhibiting a catalytic ability without repeating the adhesion process and the like. Further, it is understood from Examples 7 to 9 that the adhesion process which uses an alcohol solvent may be advantageous. Further, it is understood from Examples 1 and 10 that a reducing agent may be blended in the catalyst-catalyst carrier raw material mixed solution. Further, it is understood from Examples 1 and 11 that specifically, by using NH₃ in the raw material decomposition process, the catalyst adherence efficiency can be increased to speed up the production of the catalyst-adhered body. Further, it is understood from Examples 12 to 15 that the catalyst-adhered body capable of preparing the supported catalyst which can exhibit a good catalytic ability can be efficiently produced for supports of all particle diameters. Furthermore, it is understood from Examples 16 and 17 that even in the case of using supports of different materials, it is possible to efficiently produce a catalyst-adhered body capable of preparing the supported catalyst which can exhibit a good catalytic ability.

### INDUSTRIAL APPLICABILITY

According to the present disclosure, a catalyst-adhered body production method and a catalyst adhesion device, which achieve a good catalyst adherence efficiency, can be provided.

### REFERENCE SIGNS LIST

1 porous plate
10 container
11 upper opening
12 lower opening
30 target particles
31 adherence-treated particles
40 mixed liquid
50 upper pipe
51 upper three-way valve
52 upper air exhaust pipe
53 upper blower
54 upper fluid conduit
55 upper air exhaust device
60 lower pipe
61 lower three-way valve
62 lower air exhaust pipe
63 lower blower
64 lower fluid conduit
65 lower air exhaust device
70 excess solution storage container
71 excess solution
80 heating device
90 circulation line
100 catalyst adhesion device

1. A catalyst-adhered body production method,
comprising an adhesion process for arranging a mixed liquid comprising a catalyst raw material and/or a catalyst carrier raw material and target particles in a container having a porous plate and adhering a catalyst and/or a catalyst carrier to the surface of the target particles to obtain adherence-treated particles, an excess solution removal process for removing via the porous plate, at least a portion of an excess solution comprising excess components which did not adhere to the adherence-treated particles from the container to form a filled layer of the adherence-treated particles on the porous plate, and a drying process for drying the filled layer in the container.

2. The catalyst-adhered body production method according to claim 1, wherein the adhesion process comprises a solution supply step for supplying a solution comprising the catalyst raw material and/or the catalyst carrier raw material to the target particles filled in the container to obtain the mixed liquid.

3. The catalyst-adhered body production method according to claim 2 comprising supplying a mixed solution comprising the catalyst raw material and the catalyst carrier raw material in the solution supply step.

4. The catalyst-adhered body production method according to claim 1, wherein the adhesion process comprises a premixing step for premixing the solution containing the catalyst raw material and/or the catalyst carrier raw material with the target particles outside of the container to obtain the mixed liquid, and a mixed liquid injection step for injecting the mixed liquid obtained in the premixing step into the container.

5. The catalyst-adhered body production method according to claim 4 comprising mixing the mixed solution containing the catalyst raw material and the catalyst carrier raw material with the target particles in the premixing step.

6. The catalyst-adhered body production method according to claim 1, wherein the excess solution removal process comprises transporting the excess solution from a high pressure side space to a low pressure side space by creating a pressure difference between a space in contact with one side of the porous plate and a space in contact with the other side.

7. The catalyst-adhered body production method according to claim 1, wherein the drying process comprises flowing a gas through the filled layer of the adherence-treated particles and/or in the container.

8. The catalyst-adhered body production method according to claim 1, wherein the volume-average particle diameter of the target particles is from 0.1 mm to 2.0 mm.

9. The catalyst-adhered body production method according to claim 3, wherein the catalyst carrier raw material contains one or more elements from among Al, Si, Mg, Fe, Co, Ni, O, N, and C.

10. The catalyst-adhered body production method according to claim 1, wherein the target particles contain one or more elements from among Al, Si, Zr, O, N, and C, and the catalyst raw material contains one or more elements from among Fe, Co, and Ni.

11. The catalyst-adhered body production method according to claim 1 in which the catalyst raw material in the excess solution removed from the container by the excess solution removal process is used as at least a part of the catalyst raw material.

12. A catalyst adhesion device comprising a container containing an internal space in which at least one part of a bottom surface is defined by a porous plate, a liquid removal mechanism for removing a liquid from the internal space through the porous plate, and a drying mechanism for drying a granular material arranged in the internal space.

13. The catalyst adhesion device according to claim 12, further containing a stirring mechanism for stirring the granular material arranged in the internal space.

14. The catalyst adhesion device according to claim 12, further comprising a circulation line for making the liquid removed from the internal space via the porous plate again flow into the internal space.
